(19) United States
(12) Patent Application Publication
(10) Pub. No.: US 2026/0205535 A1
(43) Pub. Date: Jul. 16, 2026

(54) TELEPHONY AND STREAMING IN EAR-WORN DEVICE SYSTEMS INCLUDING NEURAL NETWORKS

(71) Applicant: Fortell Research Inc., New York, NY (US)

(72) Inventors: Ryan terMeulen, Watertown, MA (US); Andrew Casper, Inver Grove Heights, MN (US); Igor Lovchinsky, New York, NY (US); Matthew de Jonge, Brooklyn, NY (US)

(21) Appl. No.: 19/448,997

(22) Filed: Jan. 14, 2026

Related U.S. Application Data
(60) Provisional application No. 63/744,875, filed on Jan. 14, 2025.

(51) Int. Cl. H04M 1/60; H04M 1/72409

(52) U.S. Cl. CPC H04M 1/6008; H04M 1/724097

(57) ABSTRACT

Disclosed herein are signal paths for environmental amplification, telephony, and streaming for systems including an ear-worn device (e.g., a hearing aid, cochlear implant, or earphone) and a processing device (e.g., a smartphone or tablet). Neural network-based noise reduction may be implemented on both the ear-worn device and the processing device, and the neural network on the processing device may be different from the neural network on the ear-worn device. For example, the neural network on the processing device may have a longer latency, larger size, and/or different personalization than the neural network on the ear-worn device.

### BACKGROUND

### Field

The present disclosure relates to ear-worn devices. Some aspects relate to telephony and streaming in ear-worn device systems including neural networks.

### Related Art

Ear-worn devices, such as hearing aids, may be used to help those who have trouble hearing to hear better. Typically, ear-worn devices amplify received sound. Some ear-worn devices may attempt to reduce noise in received sound.

### SUMMARY

Systems including ear-worn devices (e.g., hearing aids, cochlear implants, or earphones) may be configured for telephony, in which audio from the wearer of the ear-worn device is transmitted from the ear-worn device to a processing device (e.g., a smartphone or tablet), and audio of a caller is transmitted from the processing device to the ear-worn device. Such systems may be also configured for streaming, in which audio (e.g., from the internet, or from memory on the processing device) is transmitted from the processing device to the ear-worn device.

Recently, neural networks for noise reduction on ear-worn devices have been developed. Further description of such neural networks may be found in U.S. Patent No. 11,812,225, titled Method, Apparatus and System for Neural Network Hearing Aid, and issued on November 7, 2023, which is incorporated by reference herein in its entirety. The inventors have recognized that neural network-based noise reduction performed by ear-worn devices may also be used for telephony and streaming. The inventors have also recognized that neural network-based noise reduction may be implemented on a processing device for telephony and streaming, and the neural network on the processing device may be different from the neural network on the ear-worn device. For example, the neural network on the processing device may have a longer latency, larger size, and/or different personalization than the neural network on the ear-worn device.

### BRIEF DESCRIPTION OF DRAWINGS

FIG. 1 illustrates an example of a system including an ear-worn device and a processing device, when the system is configured for environmental amplification, in accordance with certain embodiments described herein;

FIG. 2 illustrates an example of the system of FIG. 1 when the system is configured for telephony, in accordance with certain embodiments described herein.

FIG. 3 illustrates four example side-tone signal path options, in accordance with certain embodiments described herein.

FIG. 4 illustrates an example of the system of FIG. 1 when the system is configured for streaming, in accordance with certain embodiments described herein.

FIG. 5 illustrates an example of the system of FIG. 1 when the system is configured for streaming, in accordance with certain embodiments described herein.

FIG. 6 illustrates an example of the system of FIG. 1, in accordance with certain embodiments described herein.

FIG. 7 illustrates an example of the system of FIG. 1, in accordance with certain embodiments described herein.

FIG. 8 illustrates an example of the system of FIG. 1, in accordance with certain embodiments described herein.

FIG. 9 illustrates an example of the system of FIG. 1, in accordance with certain embodiments described herein.

FIG. 10 illustrates an example of the system of FIG. 1, in accordance with certain embodiments described herein.

FIG. 11 illustrates an example of the system of FIG. 1, in accordance with certain embodiments described herein.

FIG. 12 illustrates an example of the system of FIG. 1, in accordance with certain embodiments described herein.

FIG. 13 illustrates a hearing aid, in accordance with certain embodiments described herein.

### DETAILED DESCRIPTION

The aspects and embodiments described above, as well as additional aspects and embodiments, are described further below. These aspects and/or embodiments may be used individually, all together, or in any combination of two or more, as the disclosure is not limited in this respect.

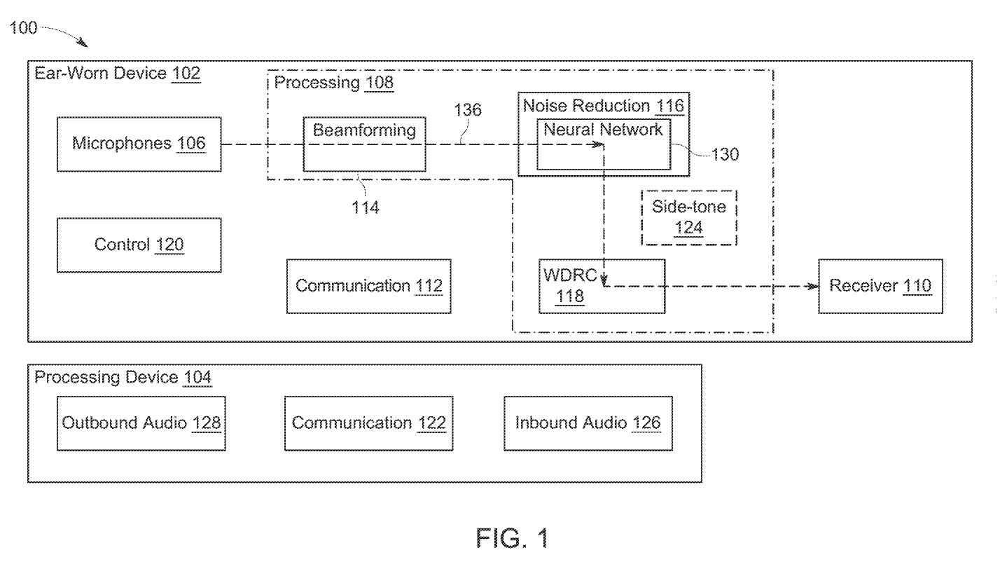

FIG. 1 illustrates an example of a system 100 including an ear-worn device 102 and a processing device 104, when the system 100 is configured for environmental amplification, in accordance with certain embodiments described herein. Environmental amplification may generally refer to amplifying sounds from the environment that are received by microphones 106 of the ear-worn device 102 and playing those amplified sounds to the wearer from the receiver 110 of the ear-worn device 102.

The ear-worn device 102 may be, for example, a hearing aid, a cochlear implant, or an earphone. The ear-worn device 102 includes one or more microphones 106, beamforming circuitry 114, noise reduction circuitry 116, wide dynamic range compression (WDRC) circuitry 118, the receiver 110, control circuitry 120, communication circuitry 112, and optional side-tone circuitry 124. The noise reduction circuitry 116 includes neural network circuitry 130. Generally, the ear-worn device 102 may include processing circuitry 108, and the processing circuitry 108 may include the beamforming circuitry 114, the noise reduction circuitry 116, the WDRC circuitry 118, and optionally the side-tone circuitry 124.

The processing device 104 may be, for example, a smartphone or tablet. The processing device 104 includes communication circuitry 122, inbound audio circuitry 126, and outbound audio circuitry 128. It should be appreciated that the ear-worn device 102 and the processing device 104 may each include more circuitry than illustrated, and such additional circuitry may be upstream, downstream, or in between any of the circuitry illustrated.

The one or more microphones 106 may include 1, 2, 3, 4, or more microphones. For example, the microphones 106 may include two microphones, a front microphone that is closer to the front of the wearer of the ear-worn device 102 and a back microphone that is closer to the back of the wearer of the ear-worn device 102. The microphones 106 may be configured to receive sound signals and generate audio signals from the sound signals.

In some embodiments, the processing circuitry 108 may include (in addition to the circuitry illustrated) analog processing circuitry. The analog processing circuitry may be configured to perform, for example, one or more of analog preamplification, analog filtering, and analog-to-digital conversion. In some embodiments, the processing circuitry 108 may include (in addition to the circuitry illustrated) digital processing circuitry. The digital processing circuitry may be configured to perform, for example, one or more of wind reduction, input calibration, and anti-feedback processing.

The beamforming circuitry 114 may be configured to generate one or more beamformed audio signals. The beamforming circuitry 114 may be configured to perform delay-and-sum processing of audio signals from different microphones 106 such that the result has a directional pattern with attenuations that vary as a function of direction-of-arrival.

The noise reduction circuitry 116 includes the neural network circuitry 130 The neural network circuitry 130 may be configured to implement one or more neural network layers. Any neural network layers described herein may be, for example, of the recurrent, vanilla/feedforward, convolutional, generative adversarial, attention (e.g. transformer), or graphical type. The neural network layers may be configured to perform noise reduction. In particular, using one or more outputs from the neural network circuitry 130, the noise reduction circuitry 116 may be configured to perform noise reduction. Generally, the noise reduction circuitry 116 may be configured to perform noise reduction using a neural network (or generally, one or more neural network layers) implemented by the neural network circuitry 130. Further description may be found in U.S. Patent No. 11,812,225, titled “Method, Apparatus and System for Neural Network Hearing Aid,” and issued on November 7, 2023, which is incorporated by reference herein in its entirety; as well as in U.S. Patent No. 11,937,047, titled “Ear-worn Device with Neural Network for Noise Reduction and/or Spatial Focusing using Multiple Input Audio Signals,” and issued on March 19, 2024, which is incorporated by reference herein in its entirety.

The WDRC circuitry 118 may be configured to perform WDRC. WDRC may include applying a non-linear, frequency-dependent gain to the incoming sound so as to fit the output sound to the hearing profile of the wearer, where more gain is applied to quiet sounds and less gain to louder sounds, in effect compressing the original signal into the dynamic range of the wearer. The processing circuitry 108 may be configured to also perform other types of processing, such as output calibration.

The receiver 110 may be configured to play back sound into the ear of the user. The receiver 110 may also be configured to implement digital-to-analog conversion prior to the playing back.

The outbound audio circuitry 128 of the processing device 104 may be configured to receive and process audio for transmitting to another device. For example, the audio may be audio from the wearer of the ear-worn device 102 during a phone call. The outbound audio circuitry 128 may include, for example, processing circuitry and circuitry for transmitting audio through a cellular network.

The inbound audio circuitry 126 of the processing device 104 may be configured to process and play audio arriving from another device. For example, the audio may be audio from a speaker on the other end of a phone call, or streaming audio arriving from another device. The inbound audio circuitry 126 may include, for example, processing circuitry and a speaker.

The communication circuitry 112 of the ear-worn device 102 may be configured to facilitate communication between the ear-worn device 102 and other devices over wireless communication links (e.g., Bluetooth or near-field magnetic induction (NFMI)). The communication circuitry 122 of the processing device 104 may be configured to facilitate communication between the processing device 104 and other devices over wireless communication links (e.g., Bluetooth or NFMI). In the case of the technology described herein, the communication circuitry 112 and the communication circuitry 122 may be configured to facilitate communication between the ear-worn device 102 and the processing device 104 over a wireless communication link (e.g., a Bluetooth or NFMI wireless communication link), which is not illustrated. When the communication circuitry 112 and 122 are configured to facilitate NFMI communication, the communication circuitry 112 and 122 may each include a magnetic induction transceiver and supporting control, audio processing, and power management circuitry. When the communication circuitry 112 and 122 are configured to facilitate Bluetooth communication, the communication circuitry 112 and 122 may each include a transceiver (e.g., a 2.4 GHz transceiver) and supporting control, audio processing, and power management circuitry.

When the system 100 is configured for environmental amplification, the ear-worn device 102 may be configured as in FIG. 1. In particular, the system 100 may be configured to implement an environmental amplification signal path 136 including the one or more microphones 106, the beamforming circuitry 114, the noise reduction circuitry 116, the WDRC circuitry 118, and the receiver 110. In the environmental amplification signal path 136, the beamforming circuitry 114 may be between the one or more microphones 106 and the noise reduction circuitry 116, the noise reduction circuitry 116 may be between the beamforming circuitry 114 and the WDRC circuitry 118, and the WDRC circuitry 118 may be between the noise reduction circuitry 116 and the receiver 110. Thus, the environmental amplification signal path 136 may include the ear-worn device 102 being configured to convert sounds into audio signals with the one or more microphones 106, beamform the audio signals using the beamforming circuitry 114, reduce noise in the audio signals using the noise reduction circuitry 116, perform WDRC on the audio signals using the WDRC circuitry 118, and output the audio signals as sound to the wearer using the receiver 110. With regards to the noise reduction performed by the noise reduction circuitry 116, the noise reduction circuitry 116 may be configured use the neural network circuitry 130 to perform the noise reduction, The neural network circuitry 130 may be configured to implement a neural network (or generally, one or more neural network layers) trained for noise reduction.

When this description or the claims refer to a signal path in which element B is between element A and element C, it should be appreciated that there may be other elements between element A and element B and/or there may be other elements between element B and element C.

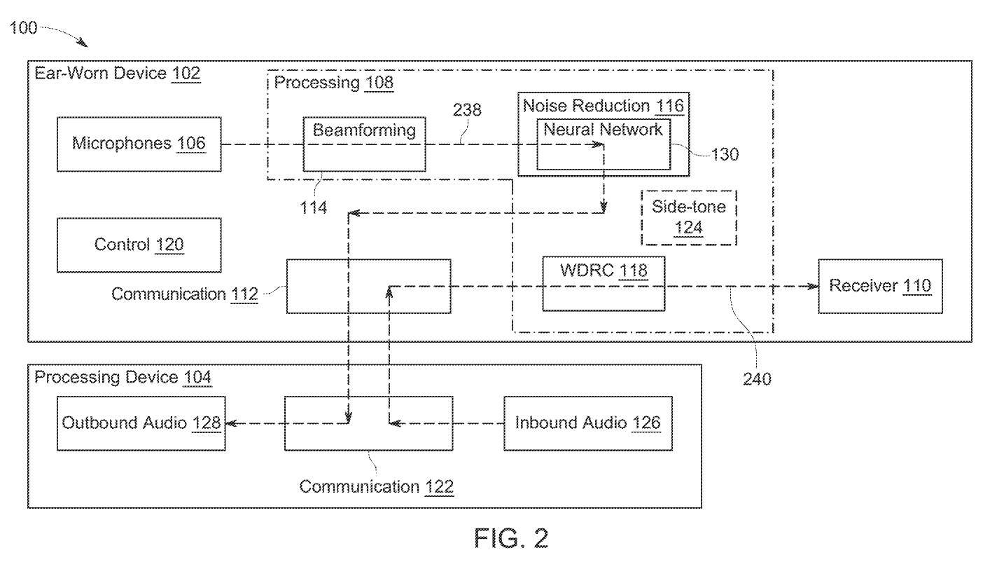

FIG. 2 illustrates an example of the system 100 when the system 100 is configured for telephony, in accordance with certain embodiments described herein. When the system 100 is configured for telephony, the system 100 may be configured to implement a telephony signal path 238 and a telephony signal path 240. Generally, the telephony signal path 238 may correspond to transmitting a wearer’s voice from the ear-worn device 102 to the processing device 104 when on a telephone call, and the telephony signal path 240 may correspond to transmitting a caller’s voice from the processing device 104 to the ear-worn device 102 when on the telephone call.

The telephony signal path 238 may include the one or more microphones 106, the beamforming circuitry 114, the noise reduction circuitry 116, the communication circuitry 112, the communication circuitry 122, and the outbound audio circuitry 128. In the telephony signal path 238, the beamforming circuitry 114 may be between the one or more microphones 106 and the noise reduction circuitry 116, the noise reduction circuitry 116 may be between the beamforming circuitry 114 and the communication circuitry 112, the communication circuitry112 may be between the noise reduction circuitry 116 and the communication circuitry 122, and the communication circuitry 122 may be between the communication circuitry 112 and the outbound audio circuitry 128. Thus, the telephony signal path 238 may include the ear-worn device 102 being configured to convert sounds into audio signals with the one or more microphones 106, reduce noise in the audio signals using the noise reduction circuitry 116, and transmit the audio signals to the processing device 104 using the communication circuitry 112. The telephony signal path 238 may further include the processing device 104 being configured to receive the audio signals from the ear-worn device 102 using the communication circuitry 122 and transmit the audio signals to another caller’s device using the outbound audio circuitry 128.

The telephony signal path 240 may include the inbound audio circuitry 126, the communication circuitry 122, the communication circuitry 112, the WDRC circuitry 118, and the receiver 110. In the telephony signal path 240, the communication circuitry 122 may be between the inbound audio circuitry 126 and the communication circuitry 112, the communication circuitry 112 may be between the communication circuitry 122 and the WDRC circuitry 118, and the WDRC circuitry 118 may be between the communication circuitry 112 and the receiver 110. Thus, the telephony signal path 240 may include the processing device 104 being configured to receive audio signals from another caller’s device using the inbound audio circuitry 126 and transmit the audio signals to the ear-worn device 102 using the communication circuitry 122. The telephony signal path 240 may further include the ear-worn device 102 being configured to receive the audio signals from the processing device 104 using the communication circuitry 112, perform WDRC on the audio signals using the WDRC circuitry 118, and output the audio signals as sound to the wearer using the receiver 110.

In some embodiments, the beamforming performed by the beamforming circuitry 114 when the system 100 is configured for environmental amplification may be different than when the system 100 is configured for telephony. When the system is configured for environmental amplification, the beamforming circuitry 114 may be configured to perform beamforming optimized for focusing on speech from in front of a wearer of the ear-worn device 102. When the system 100 is configured to telephony, the beamforming circuitry 114 may be configured to perform beamforming optimized for focusing on speech from the wearer of the ear-worn device 102 (i.e., own-voice).

In some embodiments, the control circuitry 120 may be configured to control configuration of the ear-worn device 102 for environmental amplification or for telephony. Thus, the control circuitry 120 may be configured to implement the environmental amplification signal path 136 or the telephony signal paths 238 and 240. In some embodiments, circuitry in the ear-worn device may be coupled together through switches, and the control circuitry 120 may be configured to open or close certain of the switches to implement the environmental amplification signal path 136 or the telephony signal paths 238 and 240. The control circuitry 120 may be further configured to change the beamforming performed by the beamforming circuitry 114 based on whether environmental amplification or telephony is being performed, as described above.

It should be appreciated from the above that the system 100 may be configured to use the noise reduction circuitry 116 both for environmental amplification and for telephony. In other words, the noise reduction circuitry 116 may be in both the environmental amplification signal path 136 and the telephony signal path 238.

It should be appreciated from the above that in some embodiments, the system 100 might not be configured to implement the environmental amplification signal path 136 at the same time as the telephony signal paths 138 and 140. Thus, in some embodiments, the system 100 might be configured either to implement the environmental amplification signal path 136 but not the telephony signal paths 138 and 140, or to implement the telephony signal paths 138 and 140 but not the environmental amplification signal path 136.

As illustrated in FIGS. 1 and 2, the processing circuitry 108 may further include side-tone circuitry 124. The side-tone circuitry 124 may generally be configured to provide a pathway for feeding the voice of the wearer of the ear-worn device 102 (i.e., own-voice) into the output of the receiver 110. This may be helpful, for example, for regulation of the wearer’s vocal effort, for feedback for the wearer that a call is active, and for causing own-voice to sound more natural if side-tone is filtered to counter the effect of an occluded ear canal. In some embodiments, the side-tone circuitry 124 may be configured to perform bandwidth limiting and attenuation.

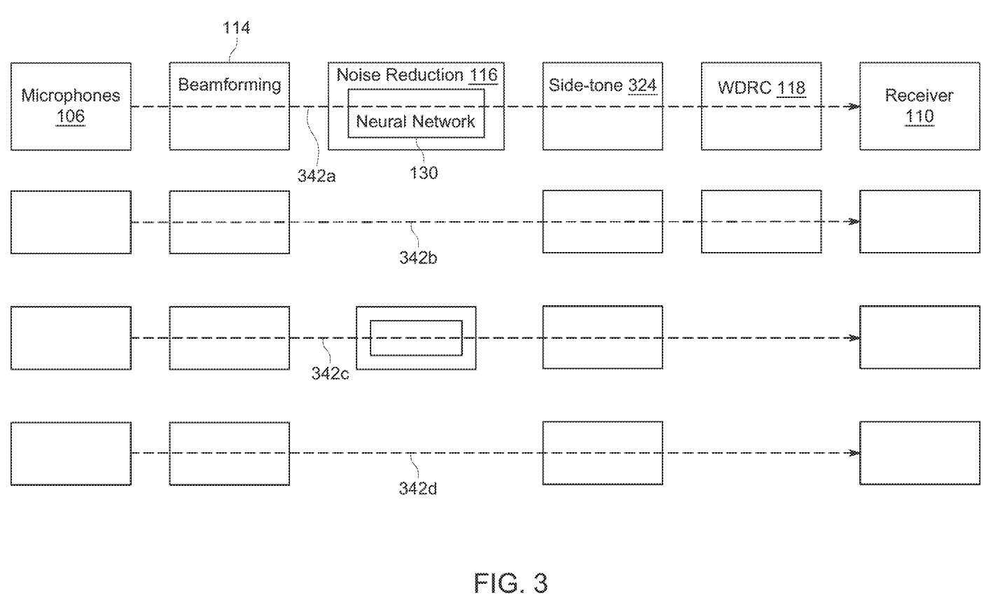

FIG. 3 illustrates four example side-tone signal path options, in accordance with certain embodiments described herein. The ear-worn device 102 may be configured to implement one of the side-tone signal paths 342a, 342b, 342c, or 324d when configured for telephony. In the side-tone signal path 342a, the side-tone circuitry 124 may be configured to receive its input signal after processing by the beamforming circuitry 114 and the noise reduction circuitry 116, and the output of the side-tone circuitry 124 may be processed by the WDRC circuitry 118. In the side-tone signal path 342b, the side-tone circuitry 124 may be configured to receive its input signal after processing by the beamforming circuitry 114 but not by the noise reduction circuitry 116, and the output of the side-tone circuitry 124 may be processed by the WDRC circuitry 118. In the side-tone signal path 342c, the side-tone circuitry 124 may be configured to receive its input signal after processing by the beamforming circuitry 114 and the noise reduction circuitry 116, and the output of the side-tone circuitry 124 might not be processed by the WDRC circuitry 118. In the side-tone signal path 342d, the side-tone circuitry 124 may be configured to receive its input signal after processing by the beamforming circuitry 114 but not by the noise reduction circuitry 116, and the output of the side-tone circuitry 124 might not be processed by the WDRC circuitry 118. In some embodiments, the system 100 may be configured to implement one of the side-tone signal paths 342a, 342b, 342c, or 342d at the same time as the telephony signal paths 238 and 240. (For simplicity, a side-tone signal path is not illustrated in FIG. 2.)

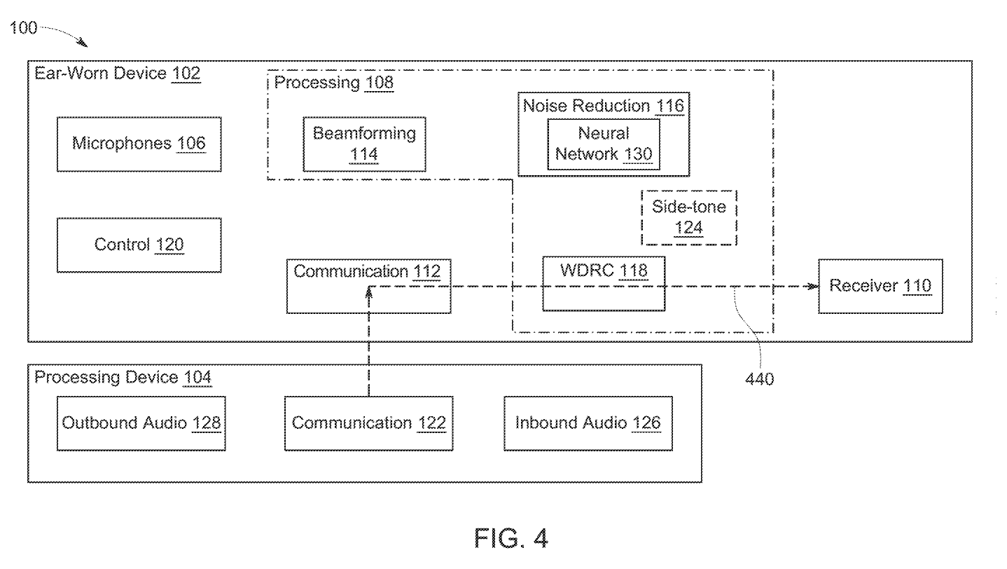

FIG. 4 illustrates an example of the system 100 when the system 100 is configured for streaming, in accordance with certain embodiments described herein. When the system 100 is configured for streaming, the system 100 may be configured to implement a streaming signal path 440. Generally, the streaming signal path 440 may correspond to receiving streaming audio by the wearer of the ear-worn device 102 from the processing device 104. The streaming audio may be, for example, received by the processing device 104 over a wireless network using the communication circuitry 122.

The streaming signal path 440 may include the communication circuitry 122, the communication circuitry 112, the WDRC circuitry 118, and the receiver 110. In the streaming signal path 440, the communication circuitry 112 may be between the communication circuitry 122 and the WDRC circuitry 118, and the WDRC circuitry 118 may be between the communication circuitry 112 and the receiver 110. Thus, the streaming signal path 440 may include the processing device 104 being configured to receive audio signals from another device over a wireless communication network using the communication circuitry 122 and transmit audio signals to the ear-worn device 102 using the communication circuitry 122. The streaming signal path 440 may further include the ear-worn device 102 being configured to receive the audio signals from the processing device 104 using the communication circuitry 112, perform WDRC on the audio signals using the WDRC circuitry 118, and output the audio signals as sound to the wearer using the receiver 110.

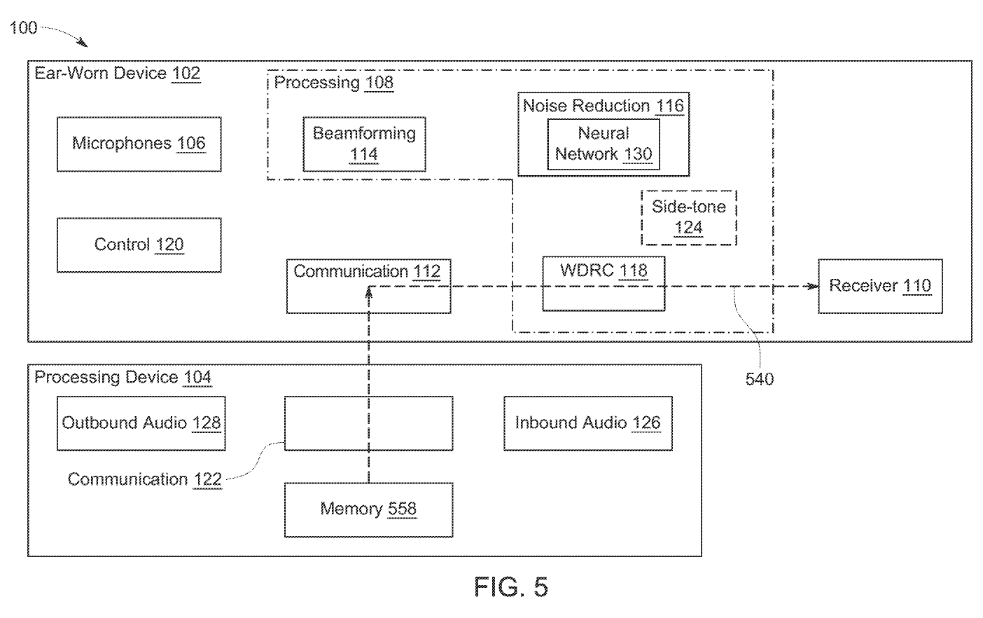

FIG. 5 illustrates an example of the system 100 when the system 100 is configured for streaming, in accordance with certain embodiments described herein. When the system 100 is configured for telephony, the system 100 may be configured to implement a streaming signal path 540. Generally, the streaming signal path 540 may correspond to receiving streaming audio by the wearer of the ear-worn device 102 from the processing device 104. The streaming audio may be, for example, retrieved by the processing device 104 from its memory 558.

The streaming signal path 540 may include the memory 558, the communication circuitry 122, the communication circuitry 112, the WDRC circuitry 118, and the receiver 110. In the streaming signal path 240, the communication circuitry 122 may be between the memory 558 and the communication circuitry 112, the communication circuitry 112 may be between the communication circuitry 122 and the WDRC circuitry 118, and the WDRC circuitry 118 may be between the communication circuitry 112 and the receiver 110. Thus, the streaming signal path 240 may include the processing device 104 being configured to retrieve audio signals from the memory 558 and transmit the audio signals to the ear-worn device 102 using the communication circuitry 122. The streaming signal path 240 may further include the ear-worn device 102 being configured to receive the audio signals from the processing device 104 using the communication circuitry 112, perform WDRC on the audio signals using the WDRC circuitry 118, and output the audio signals as sound to the wearer using the receiver 110.

In some embodiments, the control circuitry 120 may be configured to control configuration of the ear-worn device 102 for environmental amplification or for streaming. Thus, the control circuitry 120 may be configured to implement the environmental amplification signal path 136, the streaming signal path 440, or the streaming signal path 540. In some embodiments, circuitry in the ear-worn device may be coupled together through switches, and the control circuitry 120 may be configured to open or close certain of the switches to implement the environmental amplification signal path 136, the streaming signal path 440, or the streaming signal path 540.

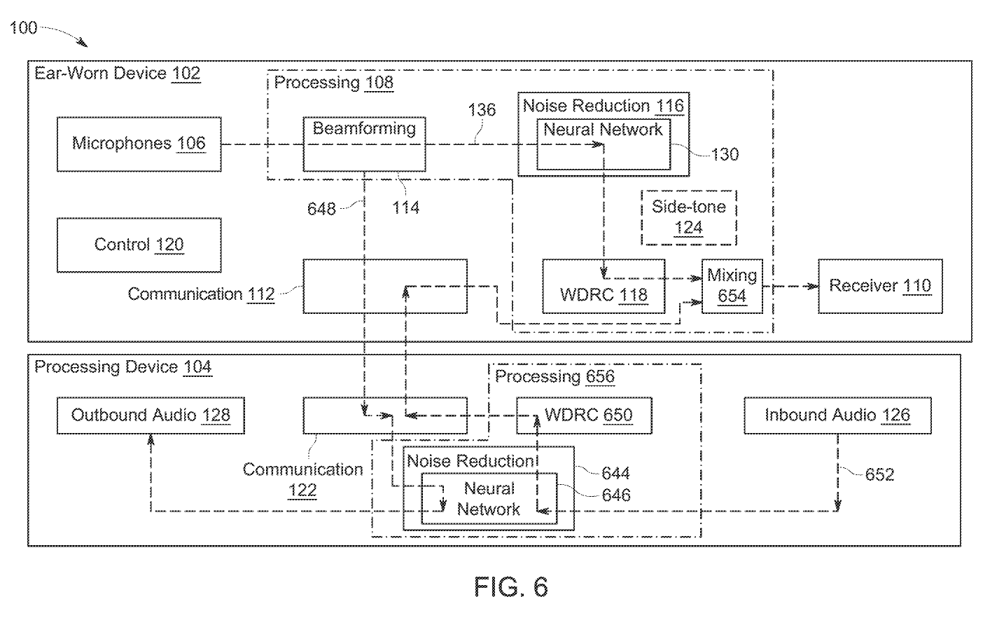

FIG. 6 illustrates an example of the system 100, in accordance with certain embodiments described herein. FIG. 6 illustrates the processing device 104 in more detail. In particular, FIG. 6 illustrates that the processing device 104 includes noise reduction circuitry 644 and WDRC circuitry 650. The noise reduction circuitry 644 includes neural network circuitry 646. Generally, the processing device 104 may include processing circuitry 656, and the processing circuitry 656 may include the noise reduction circuitry 644 and the WDRC circuitry 650. FIG. 6 further illustrates mixing circuitry 654 in the processing circuitry 108 of the ear-worn device 102.

In FIG. 6, the system 100 may be configured for telephony, but may also be configured to perform environmental amplification simultaneously. FIG. 6 illustrates a telephony signal path 648, a telephony signal path 652, and the environmental amplification signal path 136. The system 100 may thus be configured to implement the environmental amplification signal 136, the telephony signal path 648, and the telephony signal path 652 simultaneously. Further description of the environmental amplification signal path 136 may be found above.

The telephony signal path 648 may include the one or more microphones 106, the beamforming circuitry 114, the communication circuitry 112, the communication circuitry 122, the noise reduction circuitry 644, and the outbound audio circuitry 128. In the telephony signal path 648, the beamforming circuitry 114 may be between the one or more microphones 106 and the communication circuitry 112, the communication circuitry 112 may be between the beamforming circuitry 114 and the communication circuitry 122, the communication circuitry 122 may be between the communication circuitry 112 and the noise reduction circuitry 644, and the noise reduction circuitry 644 may be between the communication circuitry 122 and the outbound audio circuitry 128. Thus, the telephony signal path 648 may include the ear-worn device 102 being configured to convert sounds into audio signals with the one or more microphones 106, beamform the audio signals using the beamforming circuitry 114, and transmit the audio signals to the processing device 104 using the communication circuitry 112. The telephony signal path 648 may further include the processing device 104 being configured to receive the audio signals from the ear-worn device 102 using the communication circuitry 122, reduce noise in the audio signals using the noise reduction circuitry 644, and transmit the audio signals to another caller’s device using the outbound audio circuitry 128.

The telephony signal path 652 may include the inbound audio circuitry 126, the noise reduction circuitry 644, the WDRC circuitry 650, the communication circuitry 122, the communication circuitry 112, and the receiver 110. In the telephony signal path 652, the WDRC circuitry 650 may be between the inbound audio circuitry 126 and the noise reduction circuitry 644, the noise reduction circuitry 644 may be between the WDRC circuitry 650 and the communication circuitry 122, the communication circuitry 122 may be between the noise reduction circuitry 644 and the communication circuitry 112, and the communication circuitry 112 may be between the communication circuitry 122 and the receiver 110. Thus, the telephony signal path 652 may include the processing device 104 being configured to receive audio signals from another caller’s device using the inbound audio circuitry 126, reduce noise in the audio signals using the noise reduction circuitry 644, perform WDRC on the audio signals using the WDRC circuitry 650, and transmit the audio signals to the ear-worn device 102 using the communication circuitry 122. The telephony signal path 652 may further include the ear-worn device 102 being configured to receive the audio signals from the processing device 104 using the communication circuitry 112 and output the audio signals as sound to the wearer using the receiver 110.

In some embodiments, the beamforming performed by the beamforming circuitry 114 in the environmental amplification signal path 136 may be different from the beamforming performed by the beamforming circuitry 114 in the telephony signal path 648. In the environmental amplification signal path 136, the beamforming circuitry 114 may be configured to perform beamforming optimized for focusing on speech from in front of a wearer of the ear-worn device 102. In the telephony signal path 648, the beamforming circuitry 114 may be configured to perform beamforming optimized for focusing on speech from the wearer of the ear-worn device 102 (i.e., own-voice).

Generally, when a system is not configured to implement an environmental amplification signal path and a telephony signal path simultaneously, the two signal paths may be configured to use the same beamforming circuitry 114. The beamforming circuitry 114 may be configured to perform different beamforming depending on the signal path being implemented, as described above. When a system is configured to implement an environmental amplification signal path and a telephony signal path simultaneously, the beamforming circuitry 114 may include first beamforming circuitry and second beamforming circuitry. The environmental amplification signal path may include the first beamforming circuitry, the telephony signal path may include the second beamforming circuitry, and each beamforming circuitry may be configured differently as described above.

With regards to the noise reduction performed by the noise reduction circuitry 116, the noise reduction circuitry 116 may be configured to use the neural network circuitry 130 to perform the noise reduction. The neural network circuitry 130 may be configured to implement a neural network (or generally, one or more neural network layers) trained for noise reduction in the environmental amplification signal path 136. With regards to the noise reduction performed by the noise reduction circuitry 644, the noise reduction circuitry 644 may be configured to use the neural network circuitry 646 to perform the noise reduction in the telephony signal path 648. The neural network circuitry 646 may be configured to implement a neural network (or generally, one or more neural network layers) trained for noise reduction in the telephony signal path 644, and to implement a neural network (or generally, one or more neural network layers) trained for noise reduction in the telephony signal path 652. In some embodiments, the neural networks implemented by the neural network circuitry 646 in the telephony signal path 648 and the telephony signal path 652 may be the same. In some embodiments, the neural networks implemented by neural network circuitry 646 in the telephony signal path 648 and the telephony signal path 652 may be different. The below description will thus refer to one or more neural networks implemented by the neural network circuitry 646.

In some embodiments, the neural network implemented by the neural network circuitry 130 in the environmental amplification signal path 136 may be different from one or more of the neural networks implemented by the neural network circuitry 646 in the telephony signal paths 648 and 652. In some embodiments, one or more of the neural networks implemented by the neural network circuitry 646 in the telephony signal paths 648 and 652 may have a longer latency than the neural network implemented by the neural network circuitry 130 in the environmental amplification signal path 136. In some embodiments, latency may depend, at least in part, on the length of the frames of audio inputted to a neural network. In some embodiments, latency may depend, at least in part, on how many overlapping frames of audio inputted to a neural network are used to generate an output. Generally, longer frames of audio and/or more overlapping frames of audio may correspond to higher latency but also higher quality. For the environmental amplification signal path 136, which may generally process in- person speech, longer latencies may be less tolerable than for the telephony signal path 652. For in-person speech, sound from a speaker may enter the wearer’s ears directly (the “direct path”), as well as through the environmental amplification signal path 136 by way of the ear-worn device 102. Depending on the relative strength of those two paths, at latencies between the two paths greater than approximately 15-20 milliseconds, wearers may perceive sound passing through those two paths as echo or as two separate signals. This may be especially noticeable and distracting for the wearer’s own voice, which may be particularly loud in the direct path due to the occlusion effect. However, for not in-person speech, there will not be a direct path, and thus latency will not be limited by interference from the direct path. Instead, latency might be limited by synchronization between audio and video when both are present (e.g., in cases of telephony with accompanying video, such as a video call). The threshold for noticing a relative latency for audio versus video may be approximately 100 milliseconds. Thus, a longer latency neural network may be tolerable for the telephony signal path 652 but not for the environmental amplification signal path 136.

In some embodiments, one or more of the neural networks implemented by the neural network circuitry 646 in the telephony signal paths 648 and 652 may be larger than the neural network implemented by the neural network circuitry 130 in the environmental amplification signal path. Thus, one or more of the neural networks implemented by the neural network circuitry 646 in the telephony signal paths 648 and 652 may include more weights than the neural network implemented by the neural network circuitry 130 in the environmental amplification signal path 136. A neural network with more weights may produce higher-quality outputs than a neural network with fewer weights. The neural networks implemented by the neural network circuitry 646 in the telephony signal paths 648 and 652 may be able to be larger than the neural network implemented by the neural network circuitry 130 in the environmental amplification signal path 136 because the processing device 104 may have more available memory to store neural network weights than the ear-worn device 102.

In some embodiments, as the telephony signal path 648 may generally carry the voice of the wearer of the ear-worn device 102 in outgoing audio during calls, the neural network implemented by the neural network circuitry 646 in the telephony signal path 648 may be personalized for the wearer of the ear-worn device 102. In some embodiments, the neural network may be trained specifically on audio samples from the wearer of the ear-worn device 102. In some embodiments, the neural network might not be trained specifically on audio samples from the wearer of the ear-worn device 102, but may instead be trained to receive an embedding of the voice of the ear-worn device 102. An embedding may be a representation of a voice that the neural network may use to perform higher-quality processing of that specific voice. In some embodiments, as the telephony signal path 652 may generally carry the voice of callers to the wearer of the ear-worn device 102 in incoming audio during calls, the neural network implemented by the neural network circuitry 646 in the telephony signal path 652 may be personalized for frequent contacts of the wearer of the ear-worn device 102 (e.g., family members, friends, colleagues). In some embodiments, the neural network may be trained specifically on audio samples from the frequent callers. In some embodiments, the neural network might not be trained specifically on audio samples from frequency callers, but may instead be trained to receive embeddings of the voices of the frequency callers. Further description of personalization may be found in U.S. Patent No. 11,818,523, titled “System and Method for Enhancing Speech of Target Speaker from Audio Signal in an Ear-Worn Device using Voice Signatures,” and issued on November 14, 2023, which is incorporated by reference herein in its entirety.

As described above, the system 100 may be configured to implement the environmental signal path 136, the telephony signal path 648, and the telephony signal path 652 simultaneously. Thus, the wearer 102 may hear the caller’s incoming voice through the telephony signal path 652 while at the same time hearing environmental sounds through the environmental signal path 136. The mixing circuitry 654 may be configured to mix the output of the telephony signal path 652 with the output of the environmental amplification signal path 136 upstream of the receiver 110. In some embodiments, the processing circuitry 104 may be configured to apply attenuation to the audio of the environmental signal path 136 when a call is in progress. This may be helpful for ensuring that the environmental sounds do not interfere with the call.

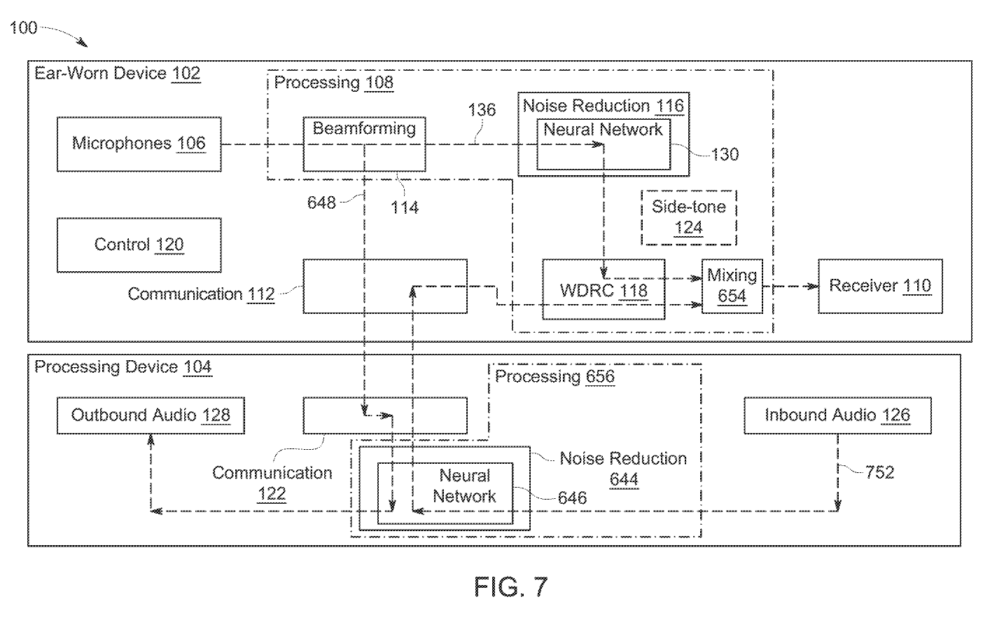

FIG. 7 illustrates an example of the system 100, in accordance with certain embodiments described herein. FIG. 7 is the same as FIG. 6, except that FIG. 7 illustrates a telephony signal path 752, in which WDRC is performed on the ear-worn device 102 by the WDRC circuitry 118 rather than on the processing device 104. Thus, the WDRC circuitry 650 on the processing device 104 may be absent. In more detail, the telephony signal path 752 may include the inbound audio circuitry 126, the noise reduction circuitry 644, the communication circuitry 122, the communication circuitry 112, the WDRC circuitry 118, and the receiver 110. In the telephony signal path 752, the noise reduction circuitry 644 may be between the inbound audio circuitry 126 and the communication circuitry 122, the communication circuitry 122 may be between the noise reduction circuitry 644 and the communication circuitry 112, the communication circuitry 112 may be between the communication circuitry 122 and the WDRC circuitry 118, and the WDRC circuitry 118 may be between the communication circuitry 112 and the receiver 110. Thus, the telephony signal path 752 may include the processing device 104 being configured to receive audio signals from another caller’s device using the inbound audio circuitry 126, reduce noise in the audio signals using the noise reduction circuitry 644, and transmit the audio signals to the ear-worn device 102 using the communication circuitry 122. The telephony signal path 752 may further include the ear-worn device 102 being configured to receive the audio signals from the processing device 104 using the communication circuitry 112, perform WDRC on the audio signals using the WDRC circuitry 118, and output the audio signals as sound to the wearer using the receiver 110.

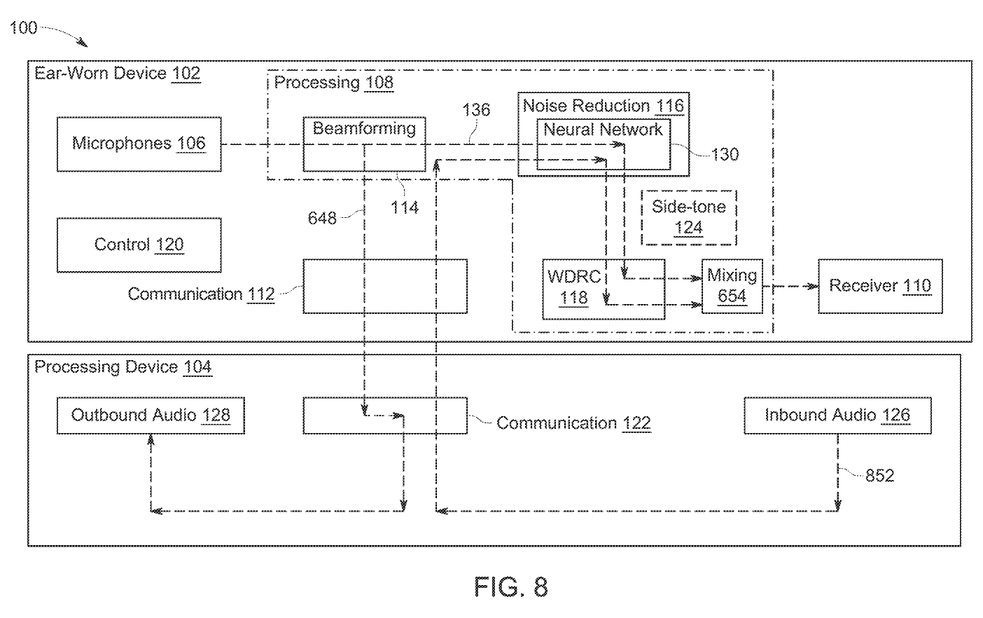

FIG. 8 illustrates an example of the system 100, in accordance with certain embodiments described herein. FIG. 8 is the same as FIG. 7, except that FIG. 8 illustrates a telephony signal path 852, in which neural network-based noise reduction is performed on the ear-worn device 102 by the noise reduction circuitry 116 rather than on the processing device 104. Thus, the noise reduction circuitry 644 on the processing device 104 may be absent (or, at least, the neural network circuitry 646 on the processing device 104 may be absent). In more detail, the telephony signal path 852 may include the inbound audio circuitry 126, the communication circuitry 122, the communication circuitry 112, the noise reduction circuitry 116, the WDRC circuitry 118, and the receiver 110. In the telephony signal path 852, the communication circuitry 122 may be between the inbound audio circuitry 126 and the communication circuitry 112, the communication circuitry 112 may be between the communication circuitry 122 and the noise reduction circuitry 116, the noise reduction circuitry 116 may be between the communication circuitry 112 and the WDRC circuitry 118, and the WDRC circuitry 118 may be between the noise reduction circuitry 116 and the receiver 110. Thus, the telephony signal path 852 may include the processing device 104 being configured to receive audio signals from another caller’s device using the inbound audio circuitry 126 and transmit the audio signals to the ear-worn device 102 using the communication circuitry 122. The telephony signal path 852 may further include the ear-worn device 102 being configured to receive the audio signals from the processing device 104 using the communication circuitry 112, reduce noise in the audio signals using the noise reduction circuitry 116, perform WDRC on the audio signals using the WDRC circuitry 118, and output the audio signals as sound to the wearer using the receiver 110.

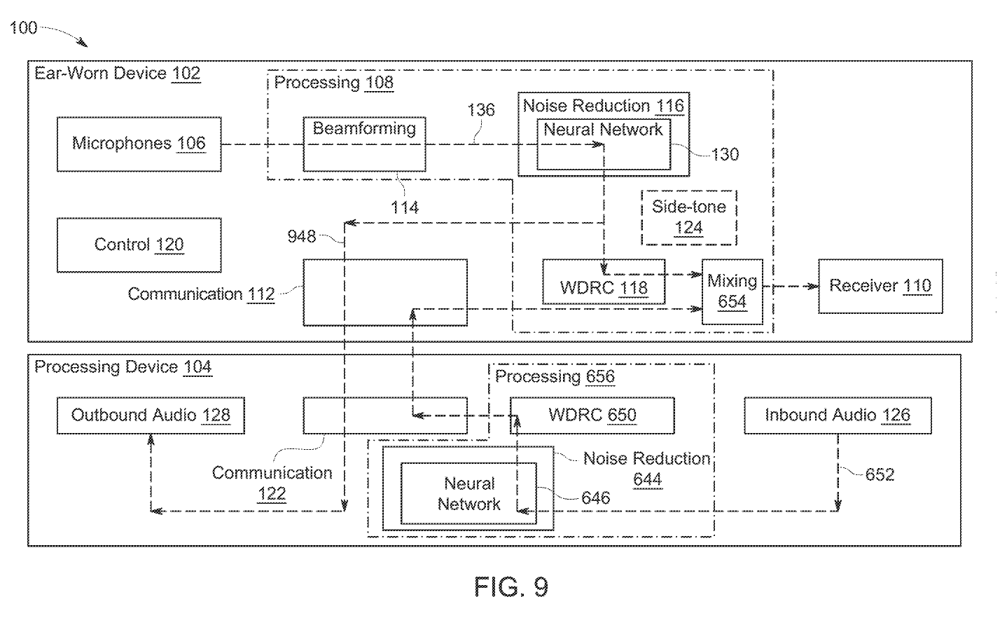

FIG. 9 illustrates an example of the system 100, in accordance with certain embodiments described herein. FIG. 9 is the same as FIG. 6, except that FIG. 9 illustrates a telephony signal path 948, in which neural network-based noise reduction is performed on the ear-worn device 102 by the noise reduction circuitry 116 rather than on the processing device 104. In more detail, the telephony signal path 948 may include the one or more microphones 106, the beamforming circuitry 114, the noise reduction circuitry 116, the communication circuitry 112, the communication circuitry 122, and the outbound audio circuitry 128. In the telephony signal path 948, the beamforming circuitry 114 may be between the one or more microphones 106 and the noise reduction circuitry 116, the noise reduction circuitry 116 may be between the beamforming circuitry 114 and the communication circuitry 112, the communication circuitry 112 may be between the noise reduction circuitry 116 and the communication circuitry 122, the communication circuitry 122 may be between the communication circuitry 112 and the noise reduction circuitry 644, and the noise reduction circuitry 644 may be between the communication circuitry 122 and the outbound audio circuitry 128. Thus, the telephony signal path 948 may include the ear-worn device 102 being configured to convert sounds into audio signals with the one or more microphones 106, beamform the audio signals using the beamforming circuitry 114, reduce noise in the audio signals using the noise reduction circuitry 116, and transmit the audio signals to the processing device 104 using the communication circuitry 112. The telephony signal path 948 may further include the processing device 104 being configured to receive the audio signals from the ear-worn device 102 using the communication circuitry 122 and transmit the audio signals to another caller’s device using the outbound audio circuitry 128.

It should be appreciated that in some embodiments, the system 100 may be configured to implement the environmental amplification signal path 136, the telephony signal path 948, and the telephony signal path 752. In some embodiments, the system 100 may be configured to implement the environmental amplification signal path 136, the telephony signal path 948, and the telephony signal path 852. In some embodiments, the control circuitry 120 may be configured to control configuration of the ear-worn device 102 for environmental amplification or for telephony. Thus, the control circuitry 120 may be configured to implement the environmental amplification signal path 136, the telephony signal path 648 or 948, and the telephony signal path 652 or 752 or 852, or the streaming signal path 540. In some embodiments, circuitry in the ear-worn device may be coupled together through switches, and the control circuitry 120 may be configured to open or close certain of the switches to implement the environmental amplification signal path and the telephony signal paths.

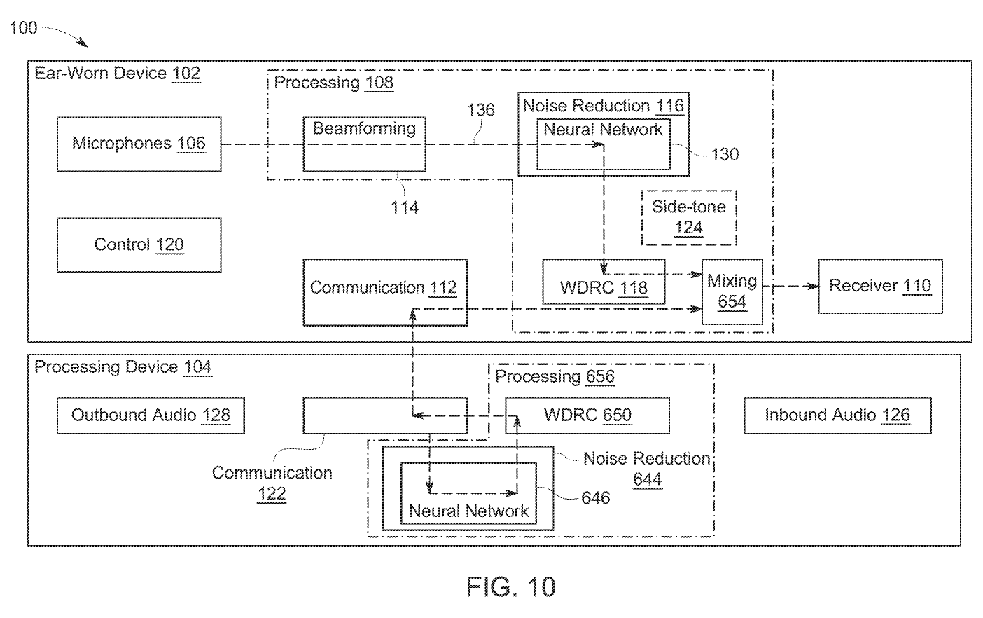

FIG. 10 illustrates an example of the system 100, in accordance with certain embodiments described herein. FIG. 10 is the same as FIG. 6, except that FIG. 10 illustrates a streaming signal path 1040. The streaming audio may be received by the processing device 104 from another device over a wireless communication network using the communication circuitry 122. Thus, the streaming audio may be outputted from the communication circuitry 122 for noise reduction and WDRC and then back to the communication circuitry 122 for transmission to the ear-worn device 102. In more detail, the streaming signal path 1040 may include the communication circuitry 122, the noise reduction circuitry 644, the WDRC circuitry 650, the communication circuitry 112, and the receiver 110. In the streaming signal path 1040, the noise reduction circuitry 644 may be between the communication circuitry 122 and the WDRC circuitry 650, the WDRC circuitry 650 may be between the noise reduction circuitry 644 and the communication circuitry 122, the communication circuitry 122 may be between the WDRC 650 and the communication circuitry 112, and the communication circuitry 112 may be between the communication circuitry 122 and the receiver 110. Thus, the streaming signal path 1040 may include the processing device 104 being configured to receive audio signals from another device over a wireless communication network using the communication circuitry 122, reduce noise in the audio signals using the noise reduction circuitry 644, perform WDRC on the audio signals using the WDRC circuitry 650, and transmit the audio signals to the ear-worn device 102 using the communication circuitry 122. The streaming signal path 1040 may further include the ear-worn device 102 being configured to receive the audio signals from the processing device 104 using the communication circuitry 112 and output the audio signals as sound to the wearer using the receiver 110.

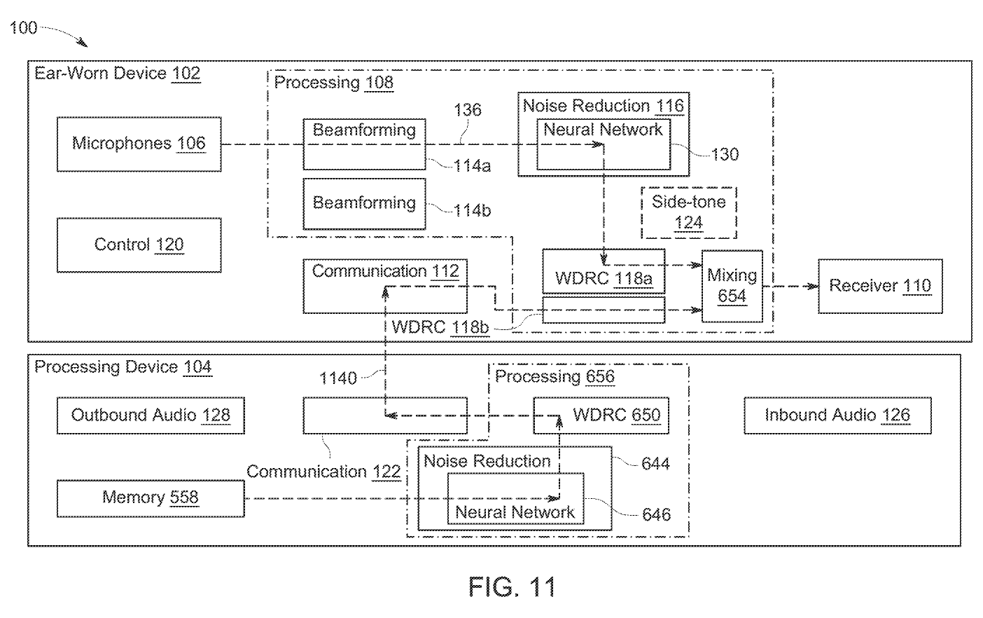

FIG. 11 illustrates an example of the system 100, in accordance with certain embodiments described herein. FIG. 11 is the same as FIG. 6, except that FIG. 11 illustrates a streaming signal path 1140. The streaming audio may be retrieved by the processing device 104 from the memory 558 on the processing device 104. In more detail, the streaming signal path 1140 may include the memory 558, the noise reduction circuitry 644, the WDRC circuitry 650, the communication circuitry 112, and the receiver 110. In the streaming signal path 1140, the noise reduction circuitry 644 may be between the memory 558 and the WDRC circuitry 650, the WDRC circuitry 650 may be between the noise reduction circuitry 644 and the communication circuitry 122, the communication circuitry 122 may be between the WDRC circuitry 650 and the communication circuitry 112, and the communication circuitry 112 may be between the communication circuitry 122 and the receiver 110. Thus, the streaming signal path 1140 may include the processing device 104 being configured to retrieve audio signals from the memory 558, reduce noise in the audio signals using the noise reduction circuitry 644, perform WDRC on the audio signals using the WDRC circuitry 650, and transmit the audio signals to the ear-worn device 102 using the communication circuitry 122. The streaming signal path 1040 may further include the ear-worn device 102 being configured to receive the audio signals from the processing device 104 using the communication circuitry 112 and output the audio signals as sound to the wearer using the receiver 110.

As described above with reference to FIGS. 7 and 8 regarding telephony signal paths, variations on the streaming signal paths 1040 and 1140 may include not performing noise reduction and/or WDRC on the processing device 104. In some embodiments, one or more of these operations may be performed on the ear-worn device 102 instead.

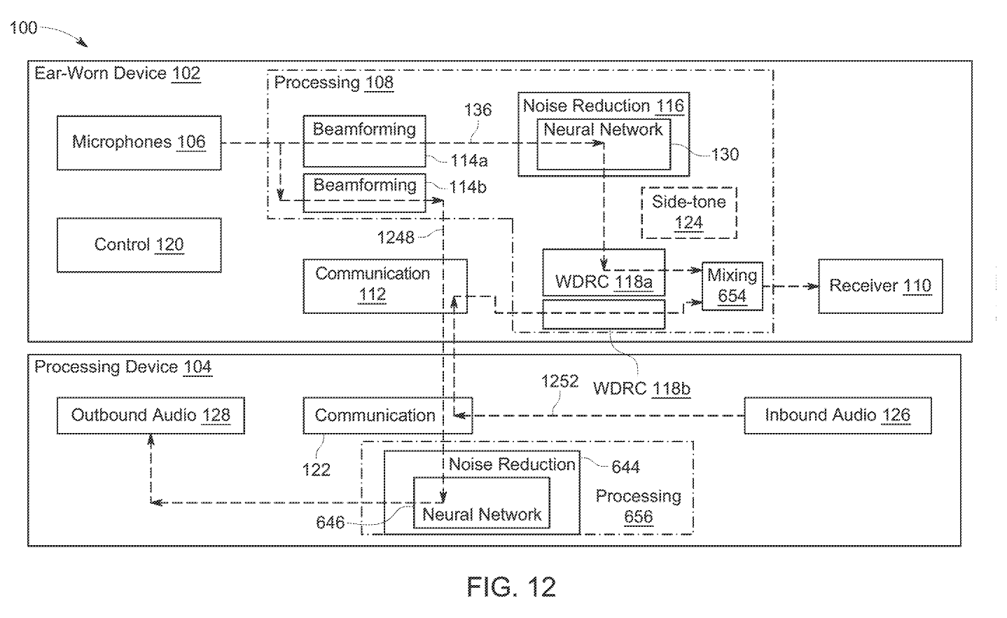

FIG. 12 illustrates an example of the system 100, in accordance with certain embodiments described herein. FIG. 12 is the same as FIG. 9, except that FIG. 9 illustrates an outbound telephony signal path 1248 and an inbound telephony signal path 1252. The outbound telephony signal path 1248 includes the one or more microphones 106, beamforming circuitry 114b, the communication circuitry 112, the communication circuitry 122, the noise reduction circuitry 644, and the outbound audio circuitry 128. In this example, the beamforming circuitry 114b may be different circuitry than the beamforming circuitry 114a of the environmental amplification signal path 136. The beamforming circuitry 114a of the environmental amplification signal path 136 may be configured to focus on speech from in front of the wearer, and the beamforming circuitry 114b of the outbound telephony signal path 1248 may be configured to focus on speech from the wearer (own-voice). The inbound telephony signal path 1252 includes the inbound audio circuitry 126, the communication circuitry 122, the communication circuitry 112, the WDRC circuitry 118b, and the receiver 110. In this example, the WDRC circuitry 118b of the inbound telephony signal path 1252 may be different circuitry than the WDRC circuitry 118a of the environmental amplification signal path 136. In some embodiments, the WDRC circuitry 118a and the WDRC circuitry 118b may function the same, or nearly the same. In some embodiments, the system 100 may be configured to implement the environmental amplification signal path 136, the outbound telephony signal path 1248, and the inbound telephony signal path 1252 simultaneously.

Generally, in some embodiments, first WDRC circuitry for an environmental amplification path may be implemented in the ear-worn device 102, and second WDRC circuitry for an inbound telephony signal path may be implemented in the ear-worn device. In some embodiments, first WDRC circuitry for an environmental amplification path may be implemented in the ear-worn device 102, and second WDRC circuitry for an inbound telephony signal path may be implemented in the processing device 104.

In some embodiments, processing circuitry 108 on the ear-worn device 102 may be configured to perform lightly compressive gain in a telephony signal path carrying inbound audio, rather than using WDRC circuitry on the ear-worn device 102 or the processing device 104. In some embodiments, side-tone may be implemented on the processing device 104, such that the wearer’s voice is fed from a telephony signal path carrying outbound own-voice audio to a telephony signal path carrying inbound audio. In some embodiments, side-tone may instead be implemented on the ear-worn device 102 as described above.

Expansion may be used to reduce the gain applied to quiet inputs near the bottom of a system's dynamic range, where signals are typically expected to be dominated by noise. For environmental audio, the level of this noise may typically map to a particular sound pressure level, and so the level at which expansion starts to be applied may be set accordingly. For telephony or streamed content, signals may typically be normalized to maximize their numerical precision before being compressed and transmitted wirelessly. The compression and decompression of the audio may contribute the main source of noise in this system, and it can be considered fixed relative to the normalized signal level. After the normalized content is received by the ear-worn device 102, a user volume may be applied that will typically attenuate both the signal and the compression noise. In some cases, only after the volume is applied does the telephony or streamed signal map to a particular sound pressure level. This sound pressure level may determine how much compression to apply in the WDRC per the user's audiogram. In a conventional WDRC, this sound pressure level may be used to decide how much expansion to apply, but that might not be sensible in this scenario since the dominant source of noise might no longer map to a particular sound pressure level; it may instead map to a constant signal level prior to applying the user volume. Thus, in some embodiments, for telephony and/or streaming WDRC (e.g., the WDRC circuitry 118b), expansion may be set relative to the original signal level, not its equivalent sound pressure level after the volume is applied. (This may be implemented when telephony/streaming and environmental amplification use different WDRC circuitries.) Compression, however, may still be applied based on the equivalent sound pressure level.

Deploying noise reduction techniques may introduce delays between when a sound is emitted by the sound source and when the noise-reduced sound is output to a user. For example, such techniques may introduce a delay between when a speaker speaks and when a listener hears the noise-reduced speech. During in-person communication, long latencies can create the perception of an echo as both the original sound and the noise-reduced version of the sound are played back to the listener. Additionally, long latencies can interfere with how the listener processes incoming sound due to the disconnect between visual cues (e.g., moving lips) and the arrival of the associated sound. To attain tolerable latencies when implementing a neural network on the ear-worn device 102, the ear-worn device 102 may need to be capable of performing billions of operations per second. To address power issues with such demanding requirements, the neural network circuitry 136 on the ear-worn device 102 may be implemented on a chip in the ear-worn device 102. In some embodiments, some or all of the processing circuitry 108 on the ear-worn device 102 may be implemented on a single same chip (i.e., a single semiconductor die or substrate). Further description of chips incorporating (in some embodiments, among other elements) neural network circuitry for use in ear-worn devices may be found in U.S. Patent No. 11,886,974, entitled “Neural Network Chip for Ear-Worn Device,” issued January 30, 2024, which is incorporated by reference herein in its entirety, as well as below.

The neutral network circuitry 130 may include circuitry configured to perform operations necessary for computing the output of a neural network layer. One such operation may be a matrix-vector multiplication. In some embodiments, the neural network circuitry 130 may include multiple identical tiles on the chip, each including multiple multiply-and-accumulate circuits configured to perform intermediate computations of a matrix-vector multiplication in parallel and then compute results of the intermediate computations into a final result. Each tile may additionally include memory configured to store neural network weights, registers configured to store input activation elements, and routing circuitry configured to facilitate communication of status and data between tiles. Other types of circuitry configured to perform processing described herein may be implemented as digital processing circuitry on the chip. In some embodiments, such digital processing circuitry may use a SIMD (single instruction multiple data) architecture. Thus, the chip may include the tiles and digital processing circuitry described above. In some embodiments, for a model having up to 10M 8-bit weights, and when operating at 100 GOPs/sec on time series data, the chip may achieve power efficiency of 4 GOPs/milliwatt, measured at 40 degrees Celsius, when the chip uses supply voltages between 0.5-1.8V, and when the chip is performing operations without idling. In some embodiments, in addition to such a chip, the ear-worn device 102 described herein may include a digital signal processor configured to perform other processing operations, and may include a separate chip for the communication circuitry 112.

As described above, the beamforming circuitry 114, the noise reduction circuitry 116, the WDRC circuitry 118, the side-tone circuitry 124, and the mixing circuitry 654 on the ear-worn device 102 may be part of the processing circuitry 108 of the ear-worn device 102. One or more of the beamforming circuitry 114, the noise reduction circuitry 116, the WDRC circuitry 118, the side-tone circuitry 124, the mixing circuitry 654 might not be dedicated portions of the processing circuitry 108 for performing these functions. Rather, the processing circuitry 108 may be reconfigurable, such that portions of the processing circuitry 108 may be configured to perform different functions at different times. However, as described above, the neural network circuitry 130 may be implemented as circuitry specialized for performing neural network computations, and thus in some embodiments, the neural network circuitry 130 may be implemented as dedicated circuitry in the processing circuitry 108. In a similar vein, the noise reduction circuitry 644 and the WDRC circuitry 650 on the processing device 104 may be part of the processing circuitry 656 of the processing device 104. One or more of the noise reduction circuitry 644 and the WDRC circuitry 650 might not be dedicated portions of the processing circuitry 656 for performing these functions. Rather, the processing circuitry 656 may be reconfigurable, such that portions of the processing circuitry 656 may be configured to perform different functions at different times.

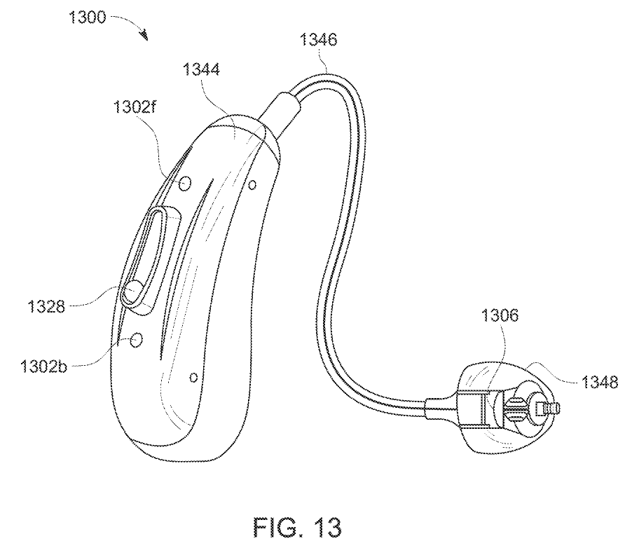

FIG. 13 illustrates a hearing aid 1300, in accordance with certain embodiments described herein. The hearing aid 1300 may be an example of any of the ear-worn devices or hearing aids described herein. The hearing aid 1300 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 1300 includes a body 1344, a receiver wire 1346, a receiver 1306 (which may correspond to the receiver 110), and a dome 1348. The body 1344 is coupled to the receiver wire 1346 and the receiver wire 1346 is coupled to the receiver 1306. The dome 1348 is placed over the receiver 1306. The body 1344 includes a front microphone 1302f, a back microphone 1302b, and a user input device 1328. (The front microphone 1302f and the back microphone 1302b may correspond to the one or more microphones 106) The body 1344 additionally includes circuitry (e.g., any of the circuitry described above, aside from the receiver 1306) not illustrated in FIG. 13. When the hearing aid 1300 is worn, the front microphone 1302f may be closer to the front of the wearer and the back microphone 1302b may be closer to the back of the wearer. The front microphone 1302f and the back microphone 1302b may be configured to receive sound signals and generate audio signals based on the sound signals. Any of the microphones described herein may be the front microphone 1302f and/or the back microphone 1302b of the hearing aid 1300. The user input device 1328 may be configured to control certain functions of the hearing aid 1300, such as switching modes.

The receiver wire 1346 may be configured to transmit audio signals from the body 1344 to the receiver 1306. The receiver 1306 may be configured to receive audio signals (i.e., those audio signals generated by the body 1344 and transmitted by the receiver wire 1346) and generate sound signals based on the audio signals. The dome 1348 may be configured to fit tightly inside the wearer’s ear and direct the sound signal produced by the receiver 1306 into the ear canal of the wearer.

In some embodiments, the length of the body 1344 may be equal to 2 cm, equal to 5 cm, or between 2 and 5 cm in length. In some embodiments, the weight of the hearing aid 1300 may be less than 4.5 grams. In some embodiments, the spacing between the microphones may be equal to 5 mm, equal to 12 mm, or between 5 and 12 mm. In some embodiments, the body 1344 may include a battery (not visible in FIG. 13), such as a lithium ion rechargeable coin cell battery.

This disclosure includes, at least, the following examples:

Example A1 is directed to a system, comprising: an ear-worn device comprising: one or more microphones; first communication circuitry; first noise reduction circuitry comprising first neural network circuitry; wide dynamic range compression (WDRC) circuitry; and a receiver; and a smartphone comprising: second communication circuitry; outbound audio circuitry; and second noise reduction circuitry comprising second neural network circuitry; wherein: the system is configured to implement: an environmental amplification signal path comprising the one or more microphones, the first noise reduction circuitry, the WDRC circuitry, and the receiver; and a telephony signal path comprising the one or more microphones, the first communication circuitry, the second communication circuitry, the second noise reduction circuitry, and the outbound audio circuitry.

Example A2 is directed to the system of example A1, wherein: the system further comprises first beamforming circuitry and second beamforming circuitry; the environmental amplification signal path further comprises the first beamforming circuitry; and the telephony signal path further comprises the second beamforming circuitry.

Example A3 is directed to the system of example A2, wherein: the first beamforming circuitry is configured to perform beamforming optimized for focusing on speech from in front of a wearer of the ear-worn device; and the second beamforming circuitry is configured to perform beamforming optimized for focusing on speech from the wearer of the ear-worn device.

Example A4 is directed to the system of any of examples A1-A3, wherein the system is configured to implement the environmental amplification signal path and the telephony path simultaneously.

Example A5 is directed to the system of example A1, wherein: the system further comprises beamforming circuitry; the environmental amplification signal path further comprises the beamforming circuitry; and the telephony signal path further comprises the beamforming circuitry.

Example A6 is directed to the system of example A5, wherein: in the environmental amplification signal path, the beamforming circuitry is configured to perform beamforming optimized for focusing on speech from in front of a wearer of the ear-worn device; and in the telephony signal path, the beamforming circuitry is configured to perform beamforming optimized for focusing on speech from the wearer of the ear-worn device.

Example A7 is directed to the system of any of examples A1-A6, wherein: the first neural network circuitry is configured to implement a first neural network trained for noise reduction in the environmental amplification signal path; and the second neural network circuitry is configured to implement a second neural network trained for noise reduction in the telephony signal path.

Example A8 is directed to the system of example A7, wherein the second neural network has a longer latency than the first neural network.

Example A9 is directed to the system of any of examples A7-A8, wherein the second neural network is larger than the first neural network.

Example A10 is directed to the system of any of examples A7-A9, wherein the second neural network is personalized for a wearer of the ear-worn device.

Example B1 is directed to a system, comprising: an ear-worn device comprising: one or more microphones; first communication circuitry; first noise reduction circuitry comprising first neural network circuitry; and wide dynamic range compression (WDRC) circuitry; and a receiver; a smartphone comprising: second communication circuitry; inbound audio circuitry; and second noise reduction circuitry comprising second neural network circuitry; wherein: the system is configured to implement: an environmental amplification signal path comprising the one or more microphones, the first noise reduction circuitry, the WDRC circuitry, and the receiver; and a telephony signal path comprising the inbound audio circuitry, the second noise reduction circuitry, the second communication circuitry, the first communication circuitry, and the receiver.

Example B2 is directed to the system of example B1, wherein the system is configured to implement the environmental amplification signal path and the telephony path simultaneously.

Example B3 is directed to the system of example B1, wherein: the system further comprises beamforming circuitry; the environmental amplification signal path further comprises the beamforming circuitry; and the first telephony signal path further comprises the beamforming circuitry.

Example B4 is directed to the system of any of examples B1-B3, wherein: the first neural network circuitry is configured to implement a first neural network trained for noise reduction in the environmental amplification signal path; and the second neural network circuitry is configured to implement a second neural network trained for noise reduction in the telephony signal path.

Example B5 is directed to the system of example B4, wherein the second neural network has a longer latency than the first neural network.

Example B6 is directed to the system of any of examples B4-B5, wherein the second neural network is larger than the first neural network.

Example B7 is directed to the system of any of examples B4-B6, wherein the second neural network is personalized for frequent callers of a wearer of the ear-worn device.

Example B8 is directed to the system of any of examples B1-B7, wherein: the WDRC circuitry comprises first WDRC circuitry; the ear-worn device further comprises second WDRC circuitry; and the telephony signal path further comprises the second WDRC circuitry.

Example B9 is directed to the system of any of examples B1-B7, wherein: the WDRC circuitry comprises first WDRC circuitry; the smartphone further comprises second WDRC circuitry; and the telephony signal path further comprises the second WDRC circuitry.

Example B10 is directed to the system of any of examples B8-B9, wherein the second WDRC circuitry is configured to implement expansion relative to an original signal level.

Example C1 is directed to a system, comprising: an ear-worn device comprising: one or more microphones; first communication circuitry; first noise reduction circuitry comprising first neural network circuitry; and wide dynamic range compression (WDRC) circuitry; and a receiver; a smartphone comprising: second communication circuitry; inbound audio circuitry; outbound audio circuitry; and second noise reduction circuitry comprising second neural network circuitry; wherein: the system is configured to implement: an environmental amplification signal path comprising the one or more microphones, the first noise reduction circuitry, the WDRC circuitry, and the receiver; a first telephony signal path comprising the one or more microphones, the first communication circuitry, the second communication circuitry, the second noise reduction circuitry, and the outbound audio circuitry; and a second telephony signal path comprising the inbound audio circuitry, the second noise reduction circuitry, the second communication circuitry, the first communication circuitry, and the receiver.

Example C2 is directed to the system of example C1, wherein: the system further comprises first beamforming circuitry and second beamforming circuitry; the environmental amplification signal path further comprises the first beamforming circuitry; and the first telephony signal path further comprises the second beamforming circuitry.

Example C3 is directed to the system of example C2, wherein: the first beamforming circuitry is configured to perform beamforming optimized for focusing on speech from in front of a wearer of the ear-worn device; and the second beamforming circuitry is configured to perform beamforming optimized for focusing on speech from the wearer of the ear-worn device.

Example C4 is directed to the system of any of examples C1-C3, wherein the system is configured to implement the environmental amplification signal path, the first telephony signal path, and the second telephony signal path simultaneously.

Example C5 is directed to the system of example C1, wherein: the system further comprises beamforming circuitry; the environmental amplification signal path further comprises the beamforming circuitry; and the first telephony signal path further comprises the beamforming circuitry.

Example C6 is directed to the system of example C5, wherein: in the environmental amplification signal path, the beamforming circuitry is configured to perform beamforming optimized for focusing on speech from in front of a wearer of the ear-worn device; and in the first telephony signal path, the beamforming circuitry is configured to perform beamforming optimized for focusing on speech from the wearer of the ear-worn device.

Example C7 is directed to the system of any of examples C1-C6, wherein: the first neural network circuitry is configured to implement a first neural network trained for noise reduction in the environmental amplification signal path; the second neural network circuitry is configured to implement a second neural network trained for noise reduction in the first telephony signal path; and the second neural network circuitry is configured to implement a third neural network trained for noise reduction in the second telephony signal path.

Example C8 is directed to the system of example C7, wherein at least one of the second neural network and the third neural network has a longer latency than the first neural network.

Example C9 is directed to the system of any of examples C7-C8, wherein at least one of the second neural network and the third neural network is larger than the first neural network.

Example C10 is directed to the system of any of examples C7-C9, wherein the second neural network is personalized for a wearer of the ear-worn device.

Example C11 is directed to the system of any of examples C7-C10, wherein the third neural network is personalized for frequent callers of a wearer of the ear-worn device.

Example C12 is directed to the system of any of examples C1-C6, wherein: the first neural network circuitry is configured to implement a first neural network trained for noise reduction in the environmental amplification signal path; and the second neural network circuitry is configured to implement a second neural network trained for noise reduction in the first and second telephony signal paths.

Example C13 is directed to the system of example C12, wherein the second neural network has a longer latency than the first neural network.

Example C14 is directed to the system of any of examples C12-C13, wherein the second neural network is larger than the first neural network.

Example C15 is directed to the system of any of examples C1-C14, wherein: the WDRC circuitry comprises first WDRC circuitry; the ear-worn device further comprises second WDRC circuitry; and the second telephony signal path further comprises the second WDRC circuitry.

Example C16 is directed to the system of any of examples C1-C14, wherein: the WDRC circuitry comprises first WDRC circuitry; the smartphone further comprises second WDRC circuitry; and the second telephony signal path further comprises the second WDRC circuitry.

Example C17 is directed to the system of any of examples C15-C16, wherein the second WDRC circuitry is configured to implement expansion relative to an original signal level.

Example D1 is directed to a system, comprising: an ear-worn device comprising: one or more microphones; first communication circuitry; first noise reduction circuitry comprising first neural network circuitry; and wide dynamic range compression (WDRC) circuitry; and a receiver; a smartphone comprising: second communication circuitry; inbound audio circuitry; outbound audio circuitry; and second noise reduction circuitry comprising second neural network circuitry; wherein: the system is configured to implement: an environmental amplification signal path comprising the one or more microphones, the first noise reduction circuitry, the WDRC circuitry, and the receiver; and a streaming signal path comprising the second noise reduction circuitry, the second communication circuitry, the first communication circuitry, and the receiver.

Example D2 is directed to the system of example D1, wherein the system is configured to implement the environmental amplification signal path and the streaming path simultaneously.

Example D3 is directed to the system of any of examples D1-D2, wherein: the first neural network circuitry is configured to implement a first neural network trained for noise reduction in the environmental amplification signal path; and the second neural network circuitry is configured to implement a second neural network trained for noise reduction in the streaming signal path.

Example D4 is directed to the system of example D3, wherein the second neural network has a longer latency than the first neural network.

Example D5 is directed to the system of any of examples D3-D4, wherein the second neural network is larger than the first neural network.

Example D6 is directed to the system of any of examples D1-D5, wherein: the WDRC circuitry comprises first WDRC circuitry; the ear-worn device further comprises second WDRC circuitry; and the streaming signal path further comprises the second WDRC circuitry.

Example D7 is directed to the system of any of examples D1-D5, wherein: the WDRC circuitry comprises first WDRC circuitry; the smartphone further comprises second WDRC circuitry; and the streaming signal path further comprises the second WDRC circuitry.

Example D8 is directed to the system of any of examples D6-D7, wherein the second WDRC circuitry is configured to implement expansion relative to an original signal level.

Example E1 is directed to a system, comprising: an ear-worn device comprising: one or more microphones; first communication circuitry; noise reduction circuitry comprising neural network circuitry; wide dynamic range compression (WDRC) circuitry; and a receiver; a processing device comprising: second communication circuitry; inbound audio circuitry; and outbound audio circuitry; wherein: the system is configured to implement: when the system is configured for environmental amplification, an environmental amplification signal path comprising the one or more microphones, the noise reduction circuitry, the WDRC circuitry, and the receiver; when the system is configured for telephony: a first telephony path comprising the one or more microphones, the noise reduction circuitry, the first communication circuitry, the second communication circuitry, and the outbound audio circuitry; and a second telephony path comprising the inbound audio circuitry, the second communication circuitry, the first communication circuitry, the WDRC circuitry, and the receiver.

Example E2 is directed to the system of example E1, wherein: the system further comprises beamforming circuitry; the environmental amplification signal path further comprises the beamforming circuitry; and the first telephony signal path further comprises the beamforming circuitry.

Example E3 is directed to the system of example E2, wherein: in the environmental amplification signal path, the beamforming circuitry is configured to perform beamforming optimized for focusing on speech from in front of a wearer of the ear-worn device; and in the first telephony signal path, the beamforming circuitry is configured to perform beamforming optimized for focusing on speech from the wearer of the ear-worn device.

Example E4 is directed to the system of any of examples E1-E3, wherein: the ear-worn device further comprises side-tone circuitry; and when the ear-worn device is configured for telephony, the ear-worn device is configured to implement a side-tone signal path comprising the one or more microphones, the noise reduction circuitry, the side-tone circuitry, the WDRC circuitry, and the receiver.

Example F1 is directed to a system, comprising: an ear-worn device comprising: one or more microphones; first communication circuitry; noise reduction circuitry comprising neural network circuitry; wide dynamic range compression (WDRC) circuitry; and a receiver; a processing device comprising: second communication circuitry; inbound audio circuitry; and outbound audio circuitry; wherein: the system is configured to implement: when the system is configured for environmental amplification, an environmental amplification signal path comprising the one or more microphones, the noise reduction circuitry, the WDRC circuitry, and the receiver; when the system is configured for streaming: a streaming path comprising the second communication circuitry, the first communication circuitry, the WDRC circuitry, and the receiver.

Example F2 is directed to the system of example F1, wherein the streaming path further comprises memory on the processing device.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. A system, comprising:
an ear-worn device comprising:
one or more microphones;
first communication circuitry;
first noise reduction circuitry comprising first neural network circuitry;
wide dynamic range compression (WDRC) circuitry; and
a receiver; and
a smartphone comprising:
second communication circuitry;
outbound audio circuitry; and
second noise reduction circuitry comprising second neural network circuitry;
wherein:
the system is configured to implement:
an environmental amplification signal path comprising the one or more microphones, the first noise reduction circuitry, the WDRC circuitry, and the receiver; and
a telephony signal path comprising the one or more microphones, the first communication circuitry, the second communication circuitry, the second noise reduction circuitry, and the outbound audio circuitry.

2. The system of claim 1, wherein:
the system further comprises first beamforming circuitry and second beamforming circuitry;
the environmental amplification signal path further comprises the first beamforming circuitry; and
the telephony signal path further comprises the second beamforming circuitry.

3. The system of claim 2, wherein:
the first beamforming circuitry is configured to perform beamforming optimized for focusing on speech from in front of a wearer of the ear-worn device; and
the second beamforming circuitry is configured to perform beamforming optimized for focusing on speech from the wearer of the ear-worn device.

4. The system of claim 1, wherein the system is configured to implement the environmental amplification signal path and the telephony path simultaneously.

5. The system of claim 1, wherein:
the system further comprises beamforming circuitry;
the environmental amplification signal path further comprises the beamforming circuitry; and
the telephony signal path further comprises the beamforming circuitry.

6. The system of claim 5, wherein:
in the environmental amplification signal path, the beamforming circuitry is configured to perform beamforming optimized for focusing on speech from in front of a wearer of the ear-worn device; and
in the telephony signal path, the beamforming circuitry is configured to perform beamforming optimized for focusing on speech from the wearer of the ear-worn device.

7. The system of claim 1, wherein:
the first neural network circuitry is configured to implement a first neural network trained for noise reduction in the environmental amplification signal path; and
the second neural network circuitry is configured to implement a second neural network trained for noise reduction in the telephony signal path.

8. The system of claim 7, wherein the second neural network has a longer latency than the first neural network.

9. The system of claim 7, wherein the second neural network is larger than the first neural network.

10. The system of claim 7, wherein the second neural network is personalized for a wearer of the ear-worn device.

11. A system, comprising:
an ear-worn device comprising:
one or more microphones;
first communication circuitry;
first noise reduction circuitry comprising first neural network circuitry;
wide dynamic range compression (WDRC) circuitry; and
a receiver;
a smartphone comprising:
second communication circuitry;
inbound audio circuitry; and
second noise reduction circuitry comprising second neural network circuitry;
wherein:
the system is configured to implement:
an environmental amplification signal path comprising the one or more microphones, the first noise reduction circuitry, the WDRC circuitry, and the receiver; and
a telephony signal path comprising the inbound audio circuitry, the second noise reduction circuitry, the second communication circuitry, the first communication circuitry, and the receiver.

12. The system of claim 11, wherein the system is configured to implement the environmental amplification signal path and the telephony path simultaneously.

13. The system of claim 11, wherein:
the system further comprises beamforming circuitry;
the environmental amplification signal path further comprises the beamforming circuitry; and
the first telephony signal path further comprises the beamforming circuitry.

14. The system of claim 11, wherein:
the first neural network circuitry is configured to implement a first neural network trained for noise reduction in the environmental amplification signal path; and
the second neural network circuitry is configured to implement a second neural network trained for noise reduction in the telephony signal path.

15. The system of claim 14, wherein the second neural network has a longer latency than the first neural network.

16. The system of claim 14, wherein the second neural network is larger than the first neural network.

17. The system of claim 14, wherein the second neural network is personalized for frequent callers of a wearer of the ear-worn device.

18. The system of claim 11, wherein:
the WDRC circuitry comprises first WDRC circuitry;
the ear-worn device further comprises second WDRC circuitry; and
the telephony signal path further comprises the second WDRC circuitry.

19. The system of claim 18, wherein the second WDRC circuitry is configured to implement expansion relative to an original signal level.

20. The system of claim 11, wherein
the WDRC circuitry comprises first WDRC circuitry;
the smartphone further comprises second WDRC circuitry; and
the telephony signal path further comprises the second WDRC circuitry.

21. The system of claim 20, wherein the second WDRC circuitry is configured to implement expansion relative to an original signal level.
